(19) United States
(12) Patent Application Publication
(10) Pub. No.: US 2026/0183733 A1
(43) Pub. Date: Jul. 2, 2026

(54) HEAT EXCHANGER WITH INTEGRATED START-UP HEATER

(71) Applicants: thyssenkrupp Uhde GmbH, Dortmund (DE); thyssenkrupp AG, Essen (DE)

(72) Inventor: Evgeni GORVAL, Dortmund (DE)

(73) Assignees: thyssenkrupp Uhde GmbH, Dortmund (DE); thyssenkrupp AG, Essen (DE)

(21) Appl. No.: 18/860,562

(22) PCT Filed: Apr. 26, 2023
(86) PCT No.: PCT/EP2023/060940

§ 371 Date: Oct. 25, 2024

(30) Foreign Application Priority Data
Apr. 27, 2022 (BE) BE2022/5309
Apr. 27, 2022 (DE) 10 2022 204 105.4

(51) Int. Cl. B01J 19/00; B01J 8/02; C01C 1/04; F28D 7/16; F28D 9/00; F28D 21/00

(52) U.S. Cl. CPC B01J 19/0013; B01J 8/0285; C01C 1/0417; F28D 7/1623; F28D 9/0006; F28D 2021/0022

(57) ABSTRACT

An ammonia synthesis gas-gas heat exchanger comprises a first gas side and a second gas side, wherein the first gas side has a first gas inlet and a first gas outlet, wherein the second gas side has a second gas inlet and a second gas outlet, wherein the first gas side has a first gas distribution region connected to the first gas inlet, wherein the first gas side has a first gas collecting region connected to the first gas outlet, wherein the first gas distribution region and the first gas collecting region are connected to one another via a plurality of first heat exchange gas ducts, wherein the first heat exchange gas ducts are in thermal contact with the second gas side, and wherein at least one first electric heating element is arranged in the first gas collecting region.

The invention relates to a heat exchanger with an integrated heater for heating for starting up a plant.

Many chemical processes, for example and especially the synthesis of ammonia from nitrogen and hydrogen, release heat, which is used to heat the reactants fed in. However, this has the effect that, when starting up such a chemical plant, the plant is initially too cold for the reaction, and the reaction thus also does not have the required heat available. It is therefore customary to supply the required energy, in particular by means of a natural gas burner. In most cases nowadays, the hydrogen for ammonia synthesis is produced from natural gas, and therefore natural gas is available in such plants.

However, there is increasing interest in reducing CO₂ emissions. There is therefore a search for alternative sources of hydrogen which manage without producing CO₂. One source, for example, is electrolysis by means of regeneratively produced power. However, this has the effect that natural gas is no longer necessarily available for the startup process, for example. On the other hand, even with such processes, the aim is then to eliminate the emission of CO₂. This therefore leads to the necessity of heating the reactants in some other way in order to reach the minimum temperature required for the reaction in the catalyst bed.

Two solutions, in particular, are currently employed for this purpose. On the one hand, an electric preheater is installed between the heat exchanger and the converter. However, since the prevailing pressures in the recirculation circuit of the ammonia synthesis system are well above 100 bar (up to 400 bar), the housing for the electric preheater must be correspondingly robust and thus complex and expensive. On the other hand, the preheater is integrated directly into the converter. Although this eliminates the necessity for a dedicated housing, the space requirement reduces the amount of catalyst in the converter and thus reduces the maximum production output.

U.S. 2019/277578 A 1 discloses an electric resistance heater of cassette-type design for preheating batteries of electric vehicles and hybrid vehicles that should be charged and discharged only in a limited temperature range in order to avoid damage to the batteries.

EP 2 116 296 A 1 discloses a startup heater for an ammonia reactor.

DE 10 2019 202 893 A 1 discloses a method for producing ammonia.

EP 3 623 343 A 1 discloses a method for producing ammonia.

WO 2017/186 613 A 1 discloses a method for heating up an ammonia converter.

EP 3 730 456 A 1 discloses the use of renewable energy for ammonia synthesis.

CN 107188197 A discloses a method for using nitrogen to heat up an ammonia synthesis catalyst.

WO 2020/150 245 A 1 discloses the use of renewable energy for synthesizing ammonia.

It is the object of the invention to allow regenerative preheating, particularly in the case of ammonia synthesis, which avoids the problems of the two known solutions.

This object is achieved by the gas-gas heat exchanger, in particular an ammonia synthesis gas-gas heat exchanger, having the features indicated in claim 1, by the chemical plant having the features indicated in claim 12, and by the method having the features indicated in claim 15.

Advantageous further developments will be found in the dependent claims, the following description and the drawings.

A heat exchanger is, in particular, an apparatus in which thermal energy is transferred from one substance stream to another substance stream, wherein the substance streams are discharged from the heat exchanger separately from one another. In a heat exchanger, therefore, one substance stream fed in is heated and another substance stream fed in is cooled. In the case of separable substance streams (for example a liquid, the vapor pressure of which does not exceed the ambient pressure in the corresponding temperature range, and a gas which is insoluble in this liquid), the substance streams can be temporarily mixed with one another in the heat exchanger for direct heat transfer. In the case of substance streams that are inseparable, these are passed through the heat exchanger while being separated spatially from one another by a heat-permeable wall (recuperator). In the case of a gas-gas heat exchanger, both substance streams are gases. In general, gases are not readily separable, and therefore these are passed through the heat exchanger while being spatially separated from one another.

The gas-gas heat exchanger according to the invention, in particular an ammonia synthesis gas-gas heat exchanger, has a first gas side and a second gas side. Here, a “gas side” is used, in particular, to denote a region (hollow region) through which a gas is passed (flows). In normal operation, thermal energy is transferred in the gas-gas heat exchanger from the gas flowing through the second gas side to the gas flowing in the first gas side. In particular, the heat produced during the conversion of the gas is used to heat the inflowing reactants. The first gas side has a first gas inlet and a first gas outlet. Here, a “gas inlet” is used, in particular, to denote an inlet opening or an inlet region of a gas side, through which a gas enters the respective gas side of the gas-gas heat exchanger. Here, a “gas outlet” is used, in particular, to denote an outlet opening or an outlet region of a gas side, through which a gas emerges from the respective gas side of the gas-gas heat exchanger. The gas stream to be heated is fed into the first gas side at the first gas inlet, and the heated gas stream is then discharged again at the gas outlet. In corresponding fashion, the second gas side has a second gas inlet and a second gas outlet. The gas which is intended to release heat is introduced through the second gas inlet, and it leaves the gas-gas heat exchanger through the second gas outlet after having been cooled down. The first gas side has a first gas distribution region connected to the first gas inlet and a first gas collecting region connected to the first gas outlet. The first gas distribution region and the first gas collecting region are connected to one another via a plurality of first heat exchange gas ducts. Here, a “heat exchange gas duct” is used, in particular, to denote a region through which the gas in the respective gas side of the gas-gas heat exchanger is passed (flows), wherein thermal energy is transferred from the gas in this gas side to the gas in the respective other gas side. By way of example and for preference, the heat exchange gas ducts can be of plate-shaped or tubular configuration. Here, a “gas distribution region” is used, in particular, to denote a region (inlet port) in which the gas that has entered the respective gas side of the gas-gas heat exchanger is distributed before it is introduced (flows) into the heat exchange gas ducts. Here, a “gas collecting region” is used, in particular, to denote a region (outlet port) in which the gas flowing out of the heat exchange gas ducts is introduced and collected before it is passed (flows) out of the gas side of the gas-gas heat exchanger via the respective gas outlet and leaves said heat exchanger. The division into a plurality of heat exchange gas ducts enlarges the surface area and thus improves heat transfer. The number of the plurality depends on the embodiment. If the embodiment is plate-shaped, for example (plate heat exchanger), 10 to 25 heat exchange gas ducts are common. If the embodiment is tubular, for example (tube bundle heat exchanger), 20 to 250 heat exchange gas ducts are more usual. A person skilled in the art will therefore choose the number comprising the plurality according to designs that are conventional in the prior art. The first heat exchange gas ducts are in thermal contact with the second gas side. This allows heat transfer. According to the invention, at least one first electric heating element is arranged in the first gas collecting region. In normal operation, the first electric heating element is switched off. Only during startup from the cold condition is it used for heating. The arrangement is chosen in such a way that the gas first of all flows through the first gas side, is electrically heated at the end thereof, and is passed from there into a conversion reactor. There is still no reaction there, however, on account of the temperature being too low. The gas then flows back into the gas-gas heat exchanger, this time on the second gas side. Here, the gas releases the electrically generated heat to the inflowing gas stream on the first gas side, which, after being heated by the returning gas, is then heated further electrically by the first electric heating element at the end of the first gas side and is thus raised to a higher temperature. In this way, both the gas stream and the conversion reactor are continuously heated until a threshold temperature has been reached, for example 370° C., in the ammonia synthesis system, with the result that the reaction in the conversion reactor begins and produces additional energy. From this time, the system is no longer dependent on the supply of external energy by the first electric heating element. The first electric heating element can either be switched off entirely or can be adjusted downward slowly until the target temperature is reached.

Arrangement in the gas-gas heat exchanger eliminates the need for a dedicated pressure-stable housing and does not reduce the space for the catalyst in the converter, thereby making it possible to solve the problems known from the prior art.

In another embodiment of the invention, the first gas collecting region has a first subregion and a second subregion. The first subregion is connected to the first heat exchange gas ducts, and the second subregion is connected to the first gas outlet. The first electric heating element is arranged in the second subregion. The effect is that, in the first subregion, the gas on the first gas side is approximately at the temperature of the gas flowing into the second gas side, and this temperature is increased further in a separate second subregion. This also allows the removal of gas streams at two different temperature levels, for example.

In another embodiment of the invention, the second subregion is thermally insulated with respect to the second gas side. This prevents the hot gas entering the second gas side from being heated further by the first electric heating element. Heating by the first electric heating element is thus restricted to the colder gas on the first gas side. For example, the thermal insulation of the second subregion can be achieved by means of a double tube if the second subregion is of tubular design. The interspace in the double tube then acts as insulation and prevents heat produced by the first electric heating element from being released to the second gas side.

In another embodiment of the invention, the first gas side has a third gas outlet. The third gas outlet is connected to the first gas collecting region. This is a preferred option especially when the first gas collecting region has different temperature levels. In particular, it is possible in this way to obtain three gas streams at different temperatures, a cooled, originally warmer, gas stream, a gas stream heated to a lower temperature that was originally colder, and a gas stream heated to a higher temperature that was originally colder, from two gas streams-a warmer gas stream and a colder gas stream.

In another embodiment of the invention, the third gas outlet is closable. As a particular preference, the third gas outlet is closed in normal operation and is opened only in a certain phase of the startup process. In particular, the third gas outlet can be closed by means of a valve.

In another embodiment of the invention, the third gas outlet is connected to the first subregion.

In another embodiment of the invention, a second electric heating element is arranged in the first subregion. In particular, a second electric heating element of this kind can be used to regulate the temperature of a gas stream, for example of the gas stream heated to a lower temperature that was originally colder.

In another embodiment of the invention, the gas-gas heat exchanger is designed as a plate heat exchanger. In this embodiment, the second gas side has a second gas distribution region connected to the second gas inlet and a second gas collecting region connected to the second gas outlet. The second gas distribution region and the second gas collecting region are connected to one another via a plurality of second heat exchange gas ducts. First heat exchange gas ducts and second heat exchange gas ducts are each arranged alternately side by side and adjoining one another over a surface area.

In another alternative embodiment of the invention, the gas-gas heat exchanger is designed as a tube bundle heat exchanger. This gives rise to two further important alternative embodiments. In a first illustrative embodiment, the second gas side can be designed as a large continuous region in which the tubular first heat exchange gas ducts run and are flowed around by the gas on the second gas side. In a second illustrative embodiment, the second gas side can have a second gas distribution region connected to the second gas inlet and a second gas collecting region connected to the second gas outlet. The second gas distribution region and the second gas collecting region are connected to one another via a plurality of second heat exchange gas ducts. First heat exchange gas ducts and second heat exchange gas ducts are each arranged in parallel side by side.

In the region of the first heat exchange gas ducts, the gas preferably flows through the second gas side in a direction counter to the gas in the first heat exchange gas ducts (countercurrent heat exchanger).

In another embodiment of the invention, the gas-gas heat exchanger has a pressure housing. “Pressure housings” are understood, in particular, to mean housings for plants or plant components which are suitable by virtue of their design (for example the choice of a suitable material of a suitable thickness and suitable configuration) for withstanding a pressure difference of at least 80 bar, preferably at least 100 bar, between a higher internal pressure and a lower external pressure.

In another aspect, the invention relates to a chemical plant comprising a gas-gas heat exchanger according to the invention, in particular an ammonia synthesis gas-gas heat exchanger. The chemical plant has a conversion reactor. The conversion reactor has a reactant inlet and a product outlet. The first gas outlet is connected to the reactant inlet, and the product outlet is connected to the second gas inlet. As a particular preference, the chemical plant is an ammonia synthesis apparatus, and the conversion reactor is a converter. The gas-gas heat exchanger according to the invention (ammonia synthesis gas-gas heat exchanger) is thus integrated into the recirculation circuit of the ammonia synthesis system.

In another embodiment of the invention, the conversion reactor has a first subreactor and a second subreactor. A secondary reactant inlet is arranged between the first subreactor and the second subreactor. The third gas outlet is connected to the secondary reactant inlet. In this way, it is possible, in particular, for a gas preheated to a lower temperature to cool the gas stream heated by the incipient reaction. As a result, the full electric heat output is available for the first reaction stage in the first subreactor, and the second subreactor is heated by the initial heat of reaction from the first subreactor.

In another aspect, the invention relates to a method for starting up a chemical plant according to the invention. The method comprises the following steps:
a) introducing cold reactant gas mixture into the first gas inlet,
b) heating the reactant gas mixture by means of the first electric heater,
c) detecting the temperature in the conversion reactor and/or of the product gas mixture leaving the product outlet,
d) determining the start of chemical conversion in the conversion reactor from the temperature detected in step c),
e) reducing the heat output of the first electric heater after the start of chemical conversion.

Here, detection in step c) can take place directly or indirectly. For example, it is also possible here to ascertain the heat released in a further heat exchanger by way of the temperature of the heat exchange medium, for example.

In another embodiment of the invention, the method is a method for starting up the abovementioned chemical plant comprising a first subreactor and a second subreactor, which additionally comprises the following steps between step d) and step e):
f) opening the connection between the third gas outlet and the secondary reactant inlet,
g) determining the start of chemical conversion in the second subreactor of the conversion reactor from the temperature detected in step c),
h) after the start of chemical conversion in the second subreactor, separating the connection between the third gas outlet and the secondary reactant inlet.

In another embodiment of the invention, in step d), the proportionate start of conversion is determined and the heat output of the first electric heater is reduced to a correspondingly proportionate extent. The advantage of this is that, on the one hand, as rapid as possible heating to the operating temperature is possible but, on the other hand, overshooting of the temperature can be prevented. This is particularly important since an elevated temperature shifts the equilibrium of the ammonia synthesis system toward the reactant side, and excessive temperatures lead to material damage.

The gas-gas heat exchanger according to the invention, in particular an ammonia synthesis gas-gas heat exchanger, is explained in greater detail below with reference to exemplary embodiments illustrated in the drawings. In the drawings:

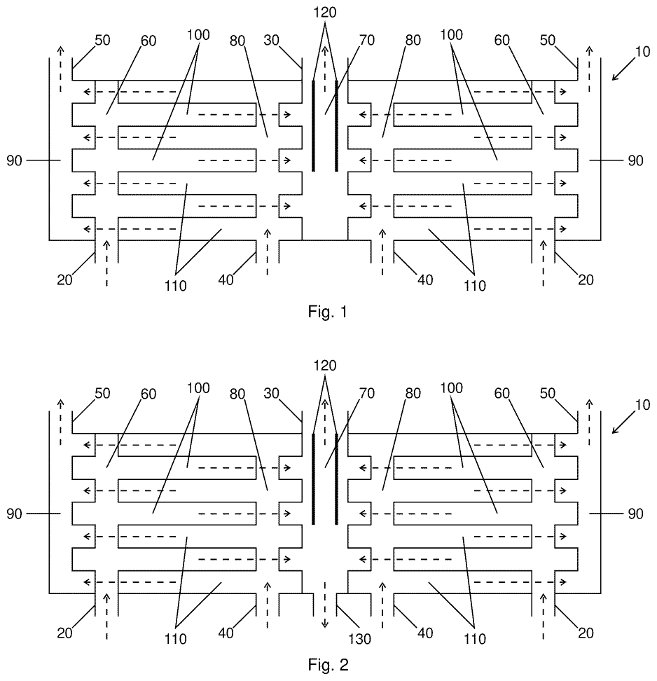

FIG. 1 shows a first illustrative embodiment,

FIG. 2 shows a second illustrative embodiment,

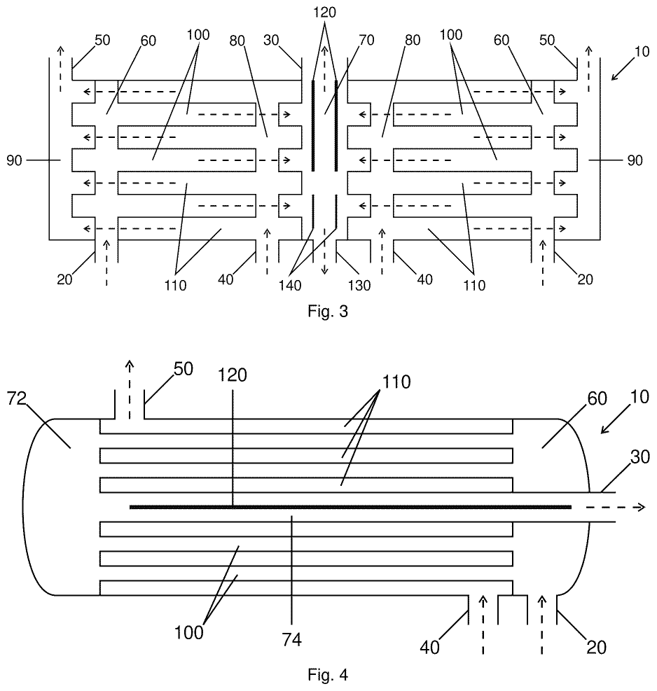

FIG. 3 shows a third illustrative embodiment,

FIG. 4 shows a fourth illustrative embodiment,

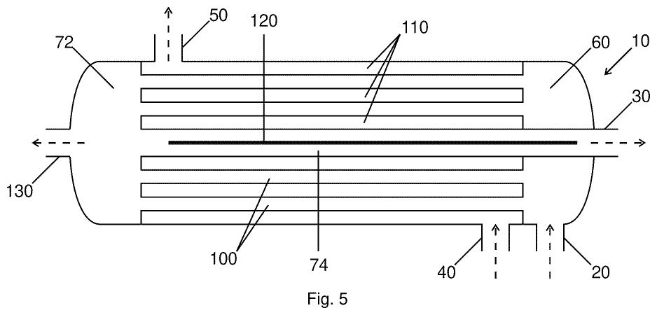

FIG. 5 shows a fifth illustrative embodiment.

FIG. 1, FIG. 2 and FIG. 3 show three illustrative plate heat exchangers, while FIG. 4 and FIG. 5 show two illustrative tube bundle heat exchangers. Identical parts are therefore provided with the same reference signs.

FIG. 1 shows a first illustrative embodiment of the gas-gas heat exchanger 10 according to the invention. The gas mixture flows in through the first gas inlet 20, which appears twice in the mirror-symmetrical structure shown. Precisely when starting up the plant, this is still cold. From there, the gas mixture enters the first gas distribution region 60 and is there distributed to the first heat exchange gas ducts 100 (three shown here by way of example). In the example shown, the first heat exchange gas ducts 100 are plate-shaped. In normal operation, the gas mixture is heated here by a countercurrent in the second heat exchange gas ducts 110. During startup, however, the gas on the second gas side is also still cold, and therefore no heating or only slight heating takes place here during startup. The gas mixture then enters the first gas collecting region 70 and is heated here by means of the first electric heating element 120. In normal operation, the first electric heating element 120 is switched off. The heated gas mixture is discharged via the first gas outlet 30 and transferred to a conversion reactor (not shown), for example a converter for ammonia synthesis. The gas mixture coming from the conversion reactor, which is warmer in normal operation than the gas mixture flowing to the gas-gas heat exchanger 10 owing to the reaction taking place in said reactor, is fed back into the gas-gas heat exchanger 10 through the second gas inlet 40. From the second gas inlet 40, the gas mixture enters the second gas distribution region 80 and, from there, enters the second heat exchange gas ducts 110, in the example shown four plate-shaped heat exchange gas ducts 110. The first heat exchange gas ducts 100 and the second heat exchange gas ducts 110 are arranged alternately. From the second heat exchange gas ducts 110, the gas mixture then enters the second gas collecting region 90 and, from there, is discharged via the second gas outlet 50.

The second illustrative embodiment, which is shown in FIG. 2, differs from the first illustrative embodiment in having a third gas outlet 130 in the first gas collecting region 70. The first gas collecting region 70 can therefore be divided conceptually into a first subregion (at the bottom, adjacent to the third gas outlet 130) and a second subregion (at the top, adjacent to the first gas outlet 30, including the first electric heating element 120). The third illustrative embodiment, which is shown in FIG. 3, differs in that a second electric heating element 140 is arranged in this conceptual first subregion.

FIG. 4 shows a fourth illustrative embodiment of the gas-gas heat exchanger 10 according to the invention. The gas mixture flows in through the first gas inlet 20. Precisely when starting up the plant, this is still cold. From there, the gas mixture enters the first gas distribution region 60 and is there distributed to the first heat exchange gas ducts 100 (four shown here by way of example). In the example shown, the first heat exchange gas ducts 100 are tubular. In normal operation, the gas mixture is heated here by a countercurrent in the second heat exchange gas ducts 110. During startup, however, the gas on the second gas side is also still cold, and therefore no heating or only slight heating takes place here during startup. The gas mixture then enters the first subregion 72 of the first gas collecting region 70 (indicated separately in FIG. 4 and FIG. 5). From there, the gas mixture enters the second subregion 74 of the first gas collecting region 70. The first electric heating element 120, which heats the gas stream, is arranged in the second subregion 74. In normal operation, the first electric heating element 120 is switched off. The heated gas mixture is discharged via the first gas outlet 30 and transferred to a conversion reactor (not shown), for example a converter for ammonia synthesis. The gas mixture coming from the conversion reactor, which is warmer in normal operation than the gas mixture flowing to the gas-gas heat exchanger 10 owing to the reaction taking place in said reactor, is fed back into the gas-gas heat exchanger 10 through the second gas inlet 40. From the second gas inlet 40, the gas mixture enters the second heat exchange gas ducts 110, in the example shown a tubular second heat exchange gas duct 110, in which the first tubular heat exchange gas ducts 100 (of which there are four in the cross section shown) are arranged. This allows heat transfer to the second heat exchange gas duct 110 via all the wall surfaces of the first heat exchange gas ducts 100. From the second heat exchange gas ducts 110, the gas mixture then reaches the second gas outlet 50 and is discharged there.

The fifth illustrative embodiment, which is shown in FIG. 5, differs from the fourth illustrative embodiment in that a third gas outlet 130 is arranged in the first subregion 72.

### REFERENCE SIGNS

10 gas-gas heat exchanger
20 first gas inlet
30 first gas outlet
40 second gas inlet
50 second gas outlet
60 first gas distribution region
70 first gas collecting region
72 first subregion
74 second subregion
80 second gas distribution region
90 second gas collecting region
100 first heat exchange gas duct
110 second heat exchange gas duct
120 first electric heating element
130 third gas outlet
140 second electric heating element

1-17. (canceled)

18. An ammonia synthesis gas-gas heat exchanger, comprising:
a first gas side and a second gas side,
wherein the first gas side has a first gas inlet and a first gas outlet,
wherein the second gas side has a second gas inlet and a second gas outlet,
wherein the first gas side has a first gas distribution region connected to the first gas inlet,
wherein the first gas side has a first gas collecting region connected to the first gas outlet,
wherein the first gas distribution region and the first gas collecting region are connected to one another via a plurality of first heat exchange gas ducts,
wherein the first heat exchange gas ducts are in thermal contact with the second gas side,
wherein at least one first electric heating element is arranged in the first gas collecting region.

19. The ammonia synthesis gas-gas heat exchanger as claimed in claim 18, wherein the first gas collecting region has a first subregion and a second subregion, wherein the first subregion is connected to the first heat exchange gas ducts, and the second subregion is connected to the first gas outlet, wherein the first electric heating element is arranged in the second subregion.

20. The ammonia synthesis gas-gas heat exchanger as claimed in claim 19, wherein the first gas side has a third gas outlet, wherein the third gas outlet is connected to the first gas collecting region.

21. The ammonia synthesis gas-gas heat exchanger as claimed in claim 20 wherein the third gas outlet is closable.

22. The ammonia synthesis gas-gas heat exchanger as claimed in claim 20, wherein the third gas outlet is connected to the first subregion.

23. The ammonia synthesis gas-gas heat exchanger as claimed in claim 22, wherein a second electric heating element is arranged in the first subregion.

24. The ammonia synthesis gas-gas heat exchanger as claimed in claim 18, wherein the ammonia synthesis gas-gas heat exchanger is designed as a plate heat exchanger.

25. The ammonia synthesis gas-gas heat exchanger as claimed in claim 18, wherein the ammonia synthesis gas-gas heat exchanger is designed as a tube bundle heat exchanger.

26. The ammonia synthesis gas-gas heat exchanger as claimed in claim 18, wherein the ammonia synthesis gas-gas heat exchanger has a pressure housing.

27. The ammonia synthesis gas-gas heat exchanger as claimed in claim 18, wherein the second subregion is thermally insulated with respect to the second gas side.

28. The ammonia synthesis gas-gas heat exchanger as claimed in claim 27, wherein the second subregion is designed in the form of a double tube.

29. A chemical plant, comprising:
an ammonia synthesis gas-gas heat exchanger as claimed in claim 18,
wherein the chemical plant has a conversion reactor,
wherein the conversion reactor has a reactant inlet and a product outlet,
wherein the first gas outlet is connected to the reactant inlet, and the product outlet is connected to the second gas inlet.

30. The chemical plant as claimed in claim 29, wherein the chemical plant is an ammonia synthesis apparatus, and the conversion reactor is an ammonia converter.

31. The chemical plant as claimed in claim 29, wherein the conversion reactor has a first subreactor and a second subreactor, wherein a secondary reactant inlet is arranged between the first subreactor and the second subreactor, wherein the third gas outlet is connected to the secondary reactant inlet.

32. A method for starting up a chemical plant as claimed in claim 31, the method comprising:
a) introducing cold reactant gas mixture into the first gas inlet,
b) heating the reactant gas mixture by means of the first electric heater,
c) detecting the temperature in the conversion reactor and/or of the product gas mixture leaving the product outlet,
d) determining the start of chemical conversion in the conversion reactor from the temperature detected in c), and
e) reducing the heat output of the first electric heater after the start of chemical conversion.

33. The method as claimed in claim 32, further comprising, between d) and e):
f) opening the connection between the third gas outlet and the secondary reactant inlet,
g) determining the start of chemical conversion in the second subreactor of the conversion reactor from the temperature detected in c), and
h) after the start of chemical conversion in the second subreactor, separating the connection between the third gas outlet and the secondary reactant inlet.

34. The method as claimed in claim 32, wherein, in d), the proportionate start of conversion is determined and the heat output of the first electric heater is reduced to a correspondingly proportionate extent.
